(19) United States
(12) Patent Application Publication
(10) Pub. No.: US 2009/0317560 A1
(43) Pub. Date: Dec. 24, 2009

(54) METHOD OF FORMING AN ULTRAVIOLET CURABLE PAINT COATING AND COATING METHOD USING AN ULTRAVIOLET CURABLE PAINT

(75) Inventors: Yi-Ching Lee, Taipei City (TW); Jui-Tsen Huang, Taipei City (TW); Po-Tau Liu, Taipei City (TW); Chan-Ming Liu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/549,342

(22) Filed: Aug. 27, 2009

Related U.S. Application Data
(63) Continuation-in-part of application No. 11/163,221, filed on Oct. 11, 2005.

(30) Foreign Application Priority Data
Mar. 15, 2005 (TW) 94107800

(51) Int. Cl. C08J 7/18; C08J 3/28

(52) U.S. Cl. 427/515; 427/508; 522/148

(57) ABSTRACT

A method of forming an ultraviolet curable paint coating is provided. First, an ultraviolet curable paint composition is formed by mixing, based on 100 parts by weight of the ultraviolet curable paint composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin, wherein a number of the functional group of the binding agent is more than that of the organosilane compound. Thereafter, a sub coating is formed by using the ultraviolet curable paint composition, and an ultraviolet curable paint coating is then formed by contacting the sub coating with a paint, wherein the unreacted hydroxyls of the sub coating react with the paint to facilitate the paint to adhere to a surface of the sub coating.

### CROSS-REFERENCE TO RELATED APPLICATION

This is a continuation-in-part application of patent application Ser. No. 11/163,221 filed on Oct. 11, 2005, which claims the priority benefit of Taiwan patent application serial no. 94107800, filed Mar. 15, 2005 and is now pending. The entirety of each of the above-mentioned patent applications is hereby incorporated by reference herein and made a part of this specification.

### BACKGROUND OF THE INVENTION

1. Field of Invention

The present invention relates to method of forming a composition of paint. More particularly, the present invention relates to a method of forming an ultraviolet curable paint coating and coating method using an ultraviolet curable paint.

2. Description of Related Art

A ultraviolet curable paint composition, a brand new green material, was developed in 1970s. Compared with the conventional paints, the ultraviolet curable paint has such advantages as less pollution, higher curable speed, less power consumption, and better property of cured product, and is suitable for temperature-sensitive material and high speed automatic production, etc. In contrast to the conventional paints which are easily volatilized, unable to cure quickly, and harmful to the environment, the ultraviolet curable paint is undoubtedly a desirable substitute for the conventional paint.

Generally, the ultraviolet curable paint is divided into two types: free radical type and cation type. The free radical type is more popular than the cation type. In detail, the photo-initiator in the free radical type ultraviolet curable paint is excited by ultraviolet ray to create free radicals, which then induce the chain reaction between a monomer and an oligomer to form a crosslinked coating.

However, as the conventional ultraviolet curable paint has high crosslink property after curing, there will be few reactive and attachable functional groups on the surface of the ultraviolet coating. Particularly, the surface energy of the ultraviolet coating is pretty low and the surface of the ultraviolet coating is rather smooth so that the coating is not easy to be reworked. As a result, the production yield is reduced. Accordingly, in order to maintain the accepted production yield in 3C industry, the conventional ultraviolet curable paint can only be applied to the appearance of small objects, but not to big objects such as a panel.

### SUMMARY OF THE INVENTION

Accordingly, the present invention is directed to a method of forming an ultraviolet curable paint coating.

Another objective of the present invention is to provide a coating method using ultraviolet curable paint, which is suitable for large size objects such as flat panel displays or notebook computers, and has an improved coating yield.

The present invention provides a method of forming an ultraviolet curable paint coating. In the method, an ultraviolet curable paint composition is formed by mixing a photo-initiator, an organosilane compound, a binding agent, a catalyst and an ultraviolet curable resin. Wherein, the content of the photo-initiator is 1 to 10 parts by weight based on 100 parts by weight of the ultraviolet curable paint composition; the content of the organosilane compound is 5 to 20 parts by weight based on 100 parts by weight of the ultraviolet curable paint composition; the content of the binding agent is 5 to 30 parts by weight based on 100 parts by weight of the ultraviolet curable paint composition, wherein a number of the functional group of the binding agent is more than a number of the functional group of the organosilane compound; and the content of the catalyst is 0.1 to 15 parts by weight based on 100 parts by weight of the ultraviolet curable paint composition. A sub coating is then formed by using the ultraviolet curable paint composition, wherein the binding agent and the organosilane compound undergo hydrolysis and condensation reactions and the binding agent has unreacted hydroxyls after the hydrolysis and condensation reactions. Thereafter, an ultraviolet curable paint coating is formed by contacting the sub coating with a paint, wherein the unreacted hydroxyls of the sub coating react with the paint to facilitate the paint to adhere to a surface of the sub coating.

The present invention also provides a coating method using ultraviolet curable paint. In the coating method, an article is provided and then a first layer of ultraviolet curable paint is coated on an appearance of the article. Thereafter, the first layer of ultraviolet curable paint is cured and the cured first layer of ultraviolet curable paint have a sufficient amount of unreacted hydroxyls on a surface thereof. Afterward, a second layer of paint is coated on the surface of the cured first layer of ultraviolet curable paint, wherein the second layer of paint reacts with the unreacted hydroxyls on the surface of the cured first layer of ultraviolet curable paint so as to form a new coating.

According to the embodiment of the present invention, the catalyst is, for example, an acid catalyst or an alkali catalyst.

According to the embodiment of the present invention, the organosilane compound is, for example, γ-glycidoxypropyltrimethoxysilane, β-(3,4-epoxycyclohexyl)-ethyl trimethoxysilane) or γ-methacryloxypropyl trimethoxysilane.

According to the embodiment of the present invention, the binding agent is, for example, a metal-hydroxide, silicon oxide or a silicon-containing alkoxide. Wherein, the metal-hydroxide is, for example, aluminum hydroxide, and the silicon-containing alkoxide is, for example, tetramethyloxysilane or tetraethyloxysilane.

According to the embodiment of the present invention, the ultraviolet curable resin is an oligomer, and it may further includes a monomer.

According to the embodiment of the present invention, the functional group of the binding agent is, for example, hydroxyl.

According to the embodiment of the present invention, the step of forming the ultraviolet curable paint composition further includes adding an auxiliary agent, such as a diluting agent, a defoaming agent or a thickening agent, etc.

According to the embodiment of the present invention, the paint is, for example, an ultraviolet curable paint which has a composition comprising, based on 100 parts by weight of the composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin.

As the present invention applies the organosilane compound and binding agent in the photo-initiator and the ultraviolet curable resin, the reactive functional group can be formed on the surface so as to make the coating formed by the composition of the present invention re-workable.

Moreover, as the present invention applies the organosilane compound, the binding agent and the catalyst in the photo-initiator and the ultraviolet curable resin, the reactive functional group can be formed on the surface of the ultraviolet coating so as to make the paint formed by the composition of the present invention re-workable. Also, the reaction time is shortened by utilizing the catalyst to catalyze the hydrolysis reaction and the condensation reaction between the organosilane compound and the binding agent.

In addition, as the organosilane compound forms an organic coating with the ultraviolet curable resin, such as a monomer or an oligomer, and the organic coating further forms a stable structure with the binding agent, the hardness of the coating formed by the ultraviolet curable paint of the present invention is thus improved effectively.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a flow chart of forming an ultraviolet curable paint coating according to one embodiment of the present invention.

FIG. 2 illustrates the sol-gel reaction mechanism of the organosilane compound.

FIG. 3 illustrates a flow chart of coating steps using an ultraviolet curable paint according to another embodiment of the present invention.

FIG. 4 illustrates the compositions of one embodiment of the present invention and the comparative sample.

### DESCRIPTION OF EMBODIMENTS

The ultraviolet curable paint composition in the present invention is at least composed of a photo-initiator, an organosilane compound, a binding agent and an ultraviolet curable resin. Preferably, the ultraviolet curable paint composition in the present invention further includes a catalyst that can shorten the reaction time. The content of the photo-initiator is 1 to 10 parts by weight based on 100 parts by weight of the ultraviolet curable paint composition. The content of the organosilane compound is 5 to 20 parts by weight based on 100 parts by weight of the ultraviolet curable paint composition. The content of the binding agent is 5 to 30 parts by weight based on 100 parts by weight of the ultraviolet curable paint composition, the content of the catalyst is 0.1 to 15 parts by weight based on 100 parts by weight of the ultraviolet curable paint composition. The term “parts by weight” herein represents usage quantity of those constituents, i.e. the photo-initiator, the organosilane compound, the binding agent, the ultraviolet curable resin and the catalyst.

In the ultraviolet curable paint composition of the present invention, the number of the functional group of the binding agent is preferred to be greater than that of the organosilane compound, and more preferably, the functional group of the binding agent is hydroxyls. In the ultraviolet curable paint composition of the present invention, the catalyst can be an acid catalyst or an alkali catalyst. Preferably, the catalyst is an acid catalyst. More preferably, the acid catalyst is, for example, hydrochloric acid, the acid value of the oligomer or the binding agent. Preferably, the alkali catalyst is, for example, sodium hydroxide solution or ammonia. The organosilane compound of the ultraviolet curable paint composition of the present invention is γ-glycidoxypropyltrimethoxysilane, β-(3,4-epoxycyclohexyl)-ethyl trimethoxysilane or γ-methacryloxypropyl trimethoxysilane, for example. Preferably, the binding agent of the ultraviolet curable paint composition of the present invention is, for example, a metal-hydroxide, silicon oxide or a silicon-containing alkoxide. More preferably, the metal-hydroxide is, for example, aluminum hydroxide, and the silicon-containing alkoxide is, for example, tetramethyloxysilane or tetraethyloxysilane. Preferably, the ultraviolet curable resin of the ultraviolet curable paint composition of the present invention is an oligomer, and more preferably, the ultraviolet curable resin further comprises a monomer.

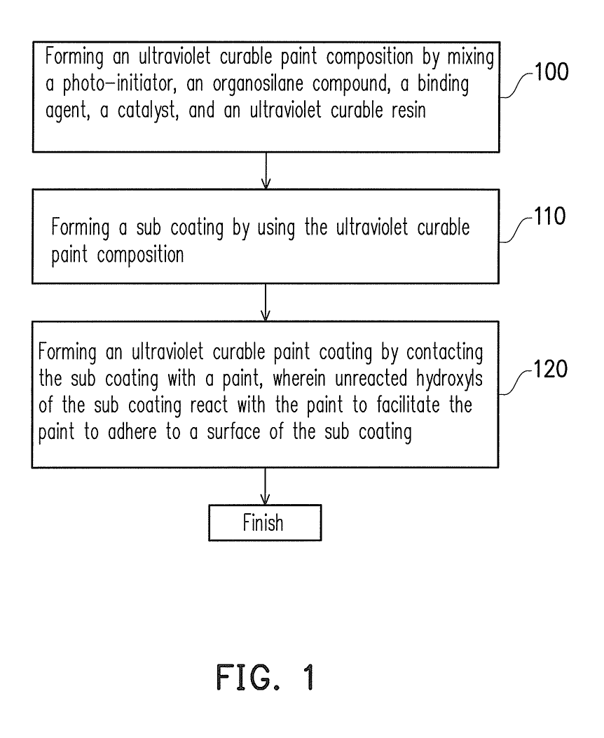

FIG. 1 illustrates a flow chart of forming an ultraviolet curable paint coating according to one embodiment of the present invention. In step 100, the ultraviolet curable paint composition is first formed by mixing the foregoing constituents, wherein a number of the functional group of the binding agent is more than a number of the functional group of the organosilane compound. Furthermore, an auxiliary agent is further added in the step 100, optionally. Preferably, the auxiliary agent is a diluting agent, a defoaming agent or a thickening agent.

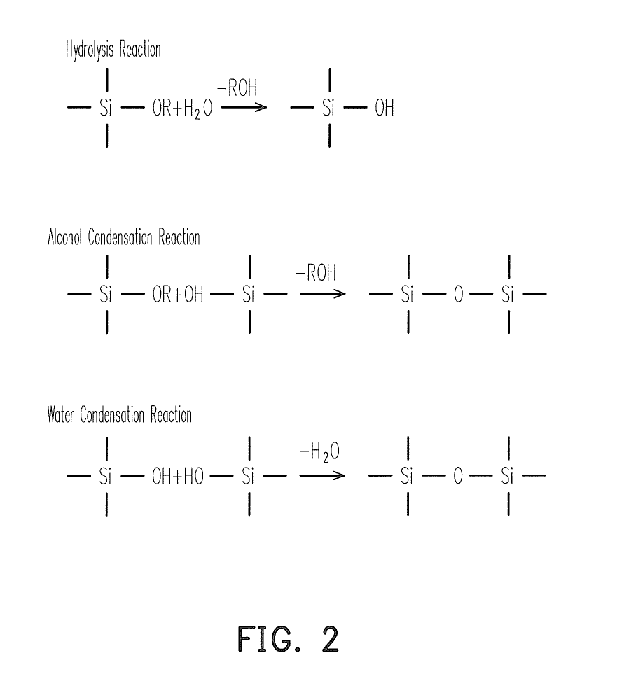

In step 110, a sub coating is formed by using the ultraviolet curable paint composition, wherein the binding agent and the organosilane compound undergo hydrolysis and condensation reactions and the binding agent has unreacted hydroxyls after the hydrolysis and condensation reactions. FIG. 2 illustrates the sol-gel reaction mechanism of the organosilane compound. The mechanism includes the hydrolysis reaction, the alcohol condensation reaction and the water condensation reaction. The present invention applies the sol-gel reaction theory to form ultraviolet curable paint composition of the present invention that has reworkability.

In step 120 of FIG. 1, an ultraviolet curable paint coating is formed by contacting the sub coating with a paint, wherein the unreacted hydroxyls of the sub coating react with the paint to facilitate the paint to adhere to a surface of the sub coating. In this embodiment, the ultraviolet curable paint coating must contain the sub coating and the paint. The composition of the paint may be the same as the sub coating or a general paint, alternatively. In other words, the paint may be an ultraviolet curable paint which has a composition comprising, based on 100 parts by weight of the composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin.

Through the modification technique of chemical formulation, the present invention increases the surface energy of the ultraviolet coating by adding the organosilane compound and the binding agent into the photo-initiator and the ultraviolet curable resin. Accordingly, re-workability of the ultraviolet coating can be achieved. With reference to formula I shown in FIG. 2, the organosilane compound has a silanol group, i.e., —SiOH after it is hydrolyzed. On the surface of the binding agent or hydrolyzed binding agent, there is hydroxyl group, i.e. —OH which may come from aluminum hydroxide or silanol group which may come from tetramethyloxysilane or tetraethyloxysilane. As shown in formula II and formula III of FIG. 2, the un-hydrolyzed silane group (—SiOR) or the hydrolyzed silanol group (—SiOH) on the surface of the organosilane compound can have condensation reaction with the hydroxyl group or silanol group on the surface of the binding agent. Accordingly, the organosilane compound combines with the binding agent. Furthermore, in the present invention, the number of the functional group on the binding agent is designed to be greater than the number of that on the organosilane compound. Therefore, the coating formed by the ultraviolet curable paint of the present invention still has some unreacted functional groups on the surface of the binding agent. The unreacted functional groups on the surface of the binding agent can react with the subsequently coated ultraviolet curable paint or general paint so as to form a reworked coating. In other words, the surface energy of the coating formed by the ultraviolet curable paint of the present invention is improved, and a reworkable ultraviolet curable paint is thus provided.

Through the addition of the organosilane compound, the binding agent, and the catalyst into the photo-initiator and the ultraviolet curable resin, the present invention improves the surface energy of the coating formed by the ultraviolet curable paint of the present invention, and thus the coating can be reworked. The principle is that the organosilane compound and the binding agent can undergo hydrolyzation reaction and condensation reaction with the aid of the catalyst. Moreover, the functional group of the organosilane compound or the hydrolyzed organosilane compound, such as the silanol, can have condensation reaction with the functional group of the binding agent or the hydrolyzed binding agent, such as hydroxyl or silanol. Therefore, as the number of the functional group of the binding agent is greater than that of the organosilane compound, there will remain some unreacted functional groups on the binding agent of the coating. The unreacted functional groups will facilitate the subsequent paint to adhere to the surface of the coating. Thus, the coating formed by the ultraviolet curable paint of the present invention can be reworked if its quality is not good enough. In addition, the reaction time is reduced due to the catalysis of the catalyst in the present invention.

As the organosilane compound has dual bonding or epoxy structure, it can form chemical bondings with the monomer or the oligomer to obtain the organosilane coating. Moreover, the organosilane coating and the nano-molecules of the inorganic binding agent can further form a stable coating. Therefore, the hardness of the coating can be improved effectively.

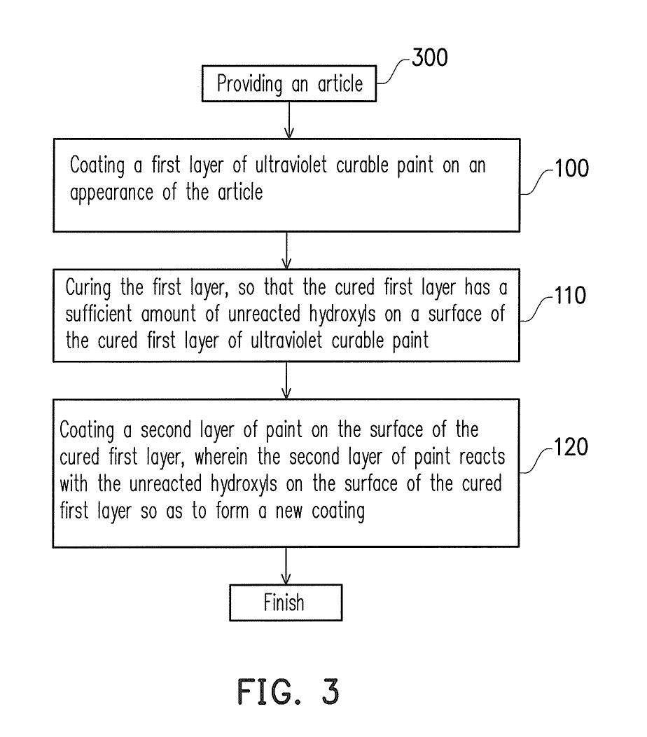

FIG. 3 illustrates a flow chart of coating steps using an ultraviolet curable paint according to another embodiment of the present invention. In step 300, an article is provided. Afterward, in step 310, a first layer of ultraviolet curable paint is coated on an appearance of the article. The first layer of ultraviolet curable paint has a composition such as the ultraviolet curable paint composition in the previous embodiment. The composition includes, based on 100 parts by weight of the composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin.

In step 320, the first layer of ultraviolet curable paint is cured, and the cured first layer of ultraviolet curable paint has a sufficient amount of unreacted hydroxyls on a surface of the cured first layer of ultraviolet curable paint.

In step 330, a second layer of paint is coated on the surface of the cured first layer of ultraviolet curable paint, wherein the second layer of paint reacts with the unreacted hydroxyls on the surface of the cured first layer of ultraviolet curable paint so as to form a new coating. In this embodiment, the sufficient amount of unreacted hydroxyls facilitates the adhesion of the second layer of paint. Moreover, the composition of the second layer of paint may be the same as the first layer of ultraviolet curable paint or a general paint, alternatively. In other words, a material of the second layer of paint is, for example, an ultraviolet curable paint such as the composition in the first layer of ultraviolet curable paint.

In the following, a preferred embodiment according to the present invention and a comparative example are illustrated to verify the reworkability of the ultraviolet curable paint of the present invention.

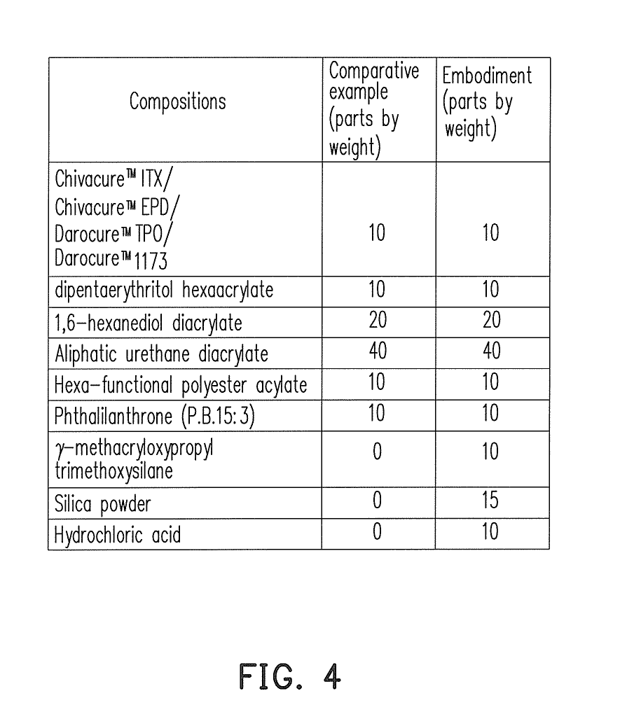

The compositions of the preferred embodiment of the present invention and the comparative sample are listed in FIG. 4. The components are evenly mixed and diluted with 1:1 BAC/IPA, respectively. After the polycarbonate (PC) substrate is coated by the above two, the drying is performed for 10 minutes at 70° C. Next, the PC substrate is irradiated by ultraviolet ray, and the amount of the overall irradiation is, for example, 500˜650 mJ/cm². Then, the cross-cut test for the adhesion is carried out. Both the test results of the preferred embodiment of the present invention and the comparative example are 5B. As for the pencil hardness test, the pencil hardness of the comparative example is H, and that of the preferred embodiment of the present invention is 2H. The result indicates that the hardness of the preferred embodiment of the present invention is indeed greater than that of the comparative example. Thereafter, the coating and drying steps aforementioned are repeated, the then cross-cut test is carried out again to verify the reworkability. The test result of the comparative example is 0B, which indicates that the coating formed by the comparative example can not be reworked. As for the coating formed by the preferred embodiment of the present invention, it indeed can be reworked successfully.

In summary, the method of the present invention at least has the following advantages:

1. The present invention improves the surface energy of the coating by adding the organosilane compound and the binding agent into the photo-initiator and the ultraviolet curable resin so that the ultraviolet curable paint in the present invention has good re-workability.

2. As the organosilane compound has dual bonding or epoxy structure, it can form chemical bonding with the ultraviolet curable resin. Moreover, the organosilane coating and the nano-molecules of the inorganic binding agent can further form a stable coating. Therefore, the hardness of the ultraviolet curable paint coating in the present invention can be improved effectively.

3. The method of forming an ultraviolet curable paint coating of the present invention is suitable for large size objects, such as a flat panel display or a notebook computer, of which the production yield is also improved significantly.

It will be apparent to those skilled in the art that various modifications and variations can be made to the present invention without departing from the scope or spirit of the invention. In view of the foregoing, it is intended that the present invention cover modifications and variations of this invention provided they fall within the scope of the following claims and their equivalents.

What is claimed is:

1. A method of forming an ultraviolet curable paint coating, comprising:
forming an ultraviolet curable paint composition by mixing, based on 100 parts by weight of the ultraviolet curable paint composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin, wherein a number of the functional group of the binding agent is more than a number of the functional group of the organosilane compound;
forming a sub coating by using the ultraviolet curable paint composition, wherein the binding agent and the organosilane compound undergo hydrolysis and condensation reactions and the binding agent has unreacted hydroxyls after the hydrolysis and condensation reactions; and
forming an ultraviolet curable paint coating by contacting the sub coating with a paint, wherein the unreacted hydroxyls of the sub coating react with the paint to facilitate the paint to adhere to a surface of the sub coating.

2. The method of forming an ultraviolet curable paint coating as claimed in claim 1, wherein the catalyst is an acid catalyst or an alkali catalyst.

3. The method of forming an ultraviolet curable paint coating as claimed in claim 1, wherein the organosilane compound is γ-glycidoxypropyltrimethoxysilane, β-(3,4-epoxycyclohexyl)-ethyl trimethoxysilane or y-methacryloxypropyl trimethoxysilane.

4. The method of forming an ultraviolet curable paint coating as claimed in claim 1, wherein the binding agent is a metal-hydroxide, silicon oxide or a silicon-containing alkoxide.

5. The method of forming an ultraviolet curable paint coating as claimed in claim 4, wherein the metal-hydroxide is aluminum hydroxide.

6. The method of forming an ultraviolet curable paint coating as claimed in claim 4, wherein the silicon-containing alkoxide is tetramethyloxysilane or tetraethyloxysilane.

7. The method of forming an ultraviolet curable paint coating as claimed in claim 1, wherein the ultraviolet curable resin is an oligomer.

8. The method of forming an ultraviolet curable paint coating as claimed in claim 7, wherein the ultraviolet curable resin further comprises a monomer.

9. The method of forming an ultraviolet curable paint coating as claimed in claim 1, wherein the step of forming the ultraviolet curable paint composition further comprising adding an auxiliary agent.

10. The method of forming an ultraviolet curable paint coating as claimed in claim 9, wherein the auxiliary agent is a diluting agent, a defoaming agent or a thickening agent.

11. The method of forming an ultraviolet curable paint coating as claimed in claim 1, wherein the paint is an ultraviolet curable paint.

12. The method of forming an ultraviolet curable paint coating as claimed in claim 11, wherein the ultraviolet curable paint has a composition comprising, based on 100 parts by weight of the composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin.

13. A coating method using ultraviolet curable paint, comprising:
providing an article;
coating a first layer of ultraviolet curable paint on an appearance of the article;
curing the first layer of ultraviolet curable paint, the cured first layer of ultraviolet curable paint having a sufficient amount of unreacted hydroxyls on a surface of the cured first layer of ultraviolet curable paint; and
coating a second layer of paint on the surface of the cured first layer of ultraviolet curable paint, wherein the second layer of paint reacts with the unreacted hydroxyls on the surface of the cured first layer of ultraviolet curable paint so as to form a new coating.

14. The coating method using ultraviolet curable paint as claimed in claim 13, wherein the first layer of ultraviolet curable paint has a composition comprising, based on 100 parts by weight of the composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin.

15. The coating method using ultraviolet curable paint as claimed in claim 13, wherein a material of the second layer of paint is an ultraviolet curable paint.

16. The coating method using ultraviolet curable paint as claimed in claim 15, wherein the ultraviolet curable paint has a composition comprising, based on 100 parts by weight of the composition, 1 to 10 parts by weight of a photo-initiator, 5 to 20 parts by weight of an organosilane compound, 5 to 30 parts by weight of a binding agent, 0.1 to 15 parts by weight of a catalyst, and an ultraviolet curable resin.

17. The coating method using ultraviolet curable paint as claimed in claim 13, wherein the sufficient amount of unreacted hydroxyls facilitates the adhesion of the second layer of paint.
